(19) United States
(12) Patent Application Publication
(10) Pub. No.: US 2018/0199400 A1
(43) Pub. Date: Jul. 12, 2018

(54) HEATING WIRE AND PLANAR HEATING SHEET INCLUDING THE SAME

(71) Applicant: Korea Institute of Machinery & Materials, Daejeon (KR)

(72) Inventors: Dong Chan LIM, Changwon-si (KR); Ki Hyon HONG, Bucheon-si (KR); Min Kyung KIM, Pohang-si, (KR); Jae Hong LIM, Changwon-si (KR); Jae Hoon JEONG, Busan (KR); Sung Mook CHOI, Changwon-si, (KR); Joo Yul LEE, Gimhae-si (KR)

(73) Assignee: Korea Institute of Machinery & Materials, Daejeon (KR)

(21) Appl. No.: 15/562,471

(22) PCT Filed: Jun. 9, 2017
(86) PCT No.: PCT/KR2017/006046

§ 371 Date: Sep. 28, 2017

(30) Foreign Application Priority Data
Jun. 10, 2016 (KR) 10-2016-0072477
Aug. 23, 2016 (KR) 10-2016-0106729
Nov. 17, 2016 (KR) 10-2016-0153211

(51) Int. Cl. H05B 3/12; H05B 3/03; H05B 3/34

(52) U.S. Cl. CPC H05B 3/12; H05B 3/03; H05B 2203/014; H05B 2214/04; H05B 3/342

(57) ABSTRACT

The present invention relates to a planar heating sheet, including a linear heating member including a single fiber body and a plurality of heating wires surrounding the single fiber body, wherein the heating wire includes a metal wire, an organic compound layer applied on the metal wire, and a metal oxide layer applied on the organic compound layer. Since the planar heating sheet is realized by a plurality of linear heating members each formed by coating a single fiber body with heating wires, each including a metal nanowire, an organic compound layer applied on the metal nanowire, and a metal oxide layer applied on the organic compound layer, this planar heating sheet can be naturally folded or bent like a general woven fabric, and thus can be used in a wide range.

### TECHNICAL FIELD

The present invention relates to a heating wire and a planar heating sheet including the same, and more particularly to a planar heating sheet having excellent exothermic characteristics and improved water resistance.

### BACKGROUND ART

In general, a planar heating sheet is used as a residential heating member for apartments, houses, and the like because it has safety, does not cause noises, and blocks the risk of electromagnetic waves as much as possible.

In addition, a planar heating sheet is used as a heating member for commercial residential areas such as offices and shopping malls, is used for industrial heating such as cars, warehouses, and various tents and used for industrial heating devices, is used for snow-removing and de-icing of agricultural facilities such as plastic tents and agricultural product drying facilities, roads, stops, runways, and bridges, and is also used for heating portable thermal equipment for rest and cold protection, health care goods, household appliances, and livestock.

A conventional planar heating sheet is generally formed by arranging heating wires at densely spaced intervals and coating these heating wires with a transparent thermal resin or the like.

Therefore, when a power is applied to the planar heating sheet, the heating wires act as resistors to generate heat, and the generated heat is used as a heat source.

However, such a conventional planar heating sheet is formed as a rigid body because its heating wires are coated with a thermal resin or the like. Therefore, this conventional planar heating sheet is limited in use because it cannot be naturally folded or bent like a general fabric.

That is, although a heating sheet having a shape of being soft and being easily folded or bent like a carpet or a woven fabric is required for general household goods, the conventional planar heating sheet cannot be used for such a purpose.

Further, it is general that heating wires are densely arranged in a zigzag form, so that the length thereof is substantially longer than the width thereof.

Therefore, when a planar heating sheet having a rigid body is folded, many structural problems, such as breakage in the middle of a heating wire, are caused.

### DISCLOSURE

### Technical Problem

Accordingly, the present invention has been made to solve the above-mentioned problems occurring in the related art, and an object to be achieved by the present invention is to provide a planar heating sheet which can be used in a wide range due to the implementation of flexible characteristics.

Additional advantages, subjects, and features of the invention will be set forth in part in the description which follows and in part will become apparent to those having ordinary skill in the art upon examination of the following or may be learned from practice of the invention.

### Technical Solution

In order to solve the above-mentioned problems, in an aspect of the present invention, there is provided a heating wire including: a metal nanowire; an organic compound layer applied on the metal nanowire; and a metal oxide layer applied on the organic compound layer.

In the heating wire, the organic compound layer is made of catecholamine or a derivative thereof.

Further, the catecholamine is at least one selected from the group consisting of dopamine, dopamine-quinone, alpha-methyldopamine, norepinephrine, epinephrine, alpha-methyldopa, droxidopa, and 5-hydroxydopamine.

Further, the metal oxide layer is made of molybdenum (Mo) oxide or tungsten (W) oxide.

In another aspect of the present invention, there is provided a planar heating sheet, including: a linear heating member including a single fiber body and a plurality of heating wires surrounding the single fiber body, wherein the heating wire includes a metal wire, an organic compound layer applied on the metal wire, and a metal oxide layer applied on the organic compound layer.

The planar heating sheet includes a plurality of linear heating members, and the plurality of linear heating members are irregularly arranged.

The planar heating sheet further includes: a first electrode connected with one side of the plurality of linear heating members; and a second electrode connected with the other side of the plurality of linear heating members, wherein a power is applied to the first electrode and the second electrode, and thereby the heating wire generates heat.

Further, the metal nanowire has a length of 10 to 50 μm.

Further, the organic compound layer is made of catecholamine or a derivative thereof.

Further, the catecholamine is at least one selected from the group consisting of dopamine, dopamine-quinone, alpha-methyldopamine, norepinephrine, epinephrine, alpha-methyldopa, droxidopa, and 5-hydroxydopamine.

Further, the metal oxide layer is made of molybdenum (Mo) oxide or tungsten (W) oxide.

In still another aspect of the present invention, there is provided a planar heating sheet, including: a base substrate; a first organic compound layer disposed on the base substrate; and a heating member disposed on the first organic compound layer, wherein the heating member includes a metal wire, a second organic compound layer disposed on the metal wire, and a metal oxide layer disposed on the second organic compound layer.

In the planar heating sheet, each of the first organic compound layer and the second organic compound layer is made of catecholamine or a derivative thereof.

Further, the catecholamine is at least one selected from the group consisting of dopamine, dopamine-quinone, alpha-methyldopamine, norepinephrine, epinephrine, alpha-methyldopa, droxidopa, and 5-hydroxydopamine.

Further, the base substrate is a support structure made of a flexible material such as vinyl, plastic, paper, or fiber.

Further, the second organic compound layer covers the metal nanowire, and the interface of the second organic compound layer and the interface of the first organic compound layer are in contact with each other.

The planar heating sheet further includes a first electrode connected with one side of the metal oxide layer, and a second electrode disposed to face the first electrode and connected with the other side of the metal oxide layer.

The second organic compound layer surrounds the outer surface of the metal nanowire, the metal oxide layer surrounds the outer surface of the second organic compound layer, and the outer surface of the metal oxide layer is in contact with the interface of the first organic compound layer.

The planar heating sheet further includes a third organic compound layer disposed on the heating member.

The third organic compound layer covers the heating member, and the interface of the third organic compound layer and the interface of the first organic compound layer are in contact with each other.

The planar heating sheet further includes a first electrode connected with one side of the third organic compound layer, and a second electrode disposed to face the first electrode and connected with the other side of the third organic compound layer.

### Advantageous Effects

As described above, since the planar heating sheet is realized by a plurality of linear heating members each formed by coating a single fiber body with heating wires, each including a metal nanowire, an organic compound layer applied on the metal nanowire, and a metal oxide layer applied on the organic compound layer, this planar heating sheet can be naturally folded or bent like a general woven fabric, and thus can be used in a wide range.

Further, due to the above heating wire structure, that is, a structure including a metal nanowire, an organic compound layer applied on the metal nanowire, and a metal oxide layer applied on the organic compound layer, the resistance of the heating wire can be lowered, and thus high exothermic characteristics can be realized even by the application of a low current.

Further, in the heating wire structure, the nanowire is coated with an organic compound layer made of dopamine, so that the waterproof properties of the heating wire can be improved, thereby improving the durability of the planar heating sheet.

Further, in the present invention, since the planar heating sheet is realized by a planar heating member or linear heating member including a metal nanowire, a second organic compound layer disposed on the metal nanowire, and a metal oxide layer disposed on the second organic compound layer and formed on a base substrate which is a support structure made of a flexible material such as vinyl, plastic, paper, or fiber, this planar heating sheet can be naturally folded or bent, and thus can be used in a wide range.

Further, in the present invention, since a first organic compound layer is formed on a base substrate, the junction characteristics between the base substrate and the metal nanowire and between the metal nanowire and the metal nanowire are improved, so that stable exothermic characteristics can be realized even when a higher voltage is applied.

### DESCRIPTION OF DRAWINGS

FIG. 1 is a view for explaining a planar heating sheet according to a first embodiment of the present invention.

FIG. 2 is an enlarged photograph of a linear heating member according to the present invention.

FIG. 3 is an enlarged photograph of a plurality of heating wires according to the present invention, and FIG. 4 is a sectional view taken along the line I-I of FIG. 3.

FIG. 5 is a photograph showing a junction between a metal nanowire and a metal nanowire;

FIG. 6 is a graph showing the resistance characteristics of the planar heating sheets according to Example 1 and Comparative Examples 1 and 2;

FIG. 7 is an image view showing the exothermic characteristics of the planar heating sheet according to Example 1;

FIG. 8 is a view showing the results of a water resistance test according to Comparative Example 1, FIG. 9 is a view showing the results of a water resistance test according to Comparative Example 2, and FIG. 10 is a view showing the results of a water resistance test according to Example 1.

FIG. 11 is a photograph showing application examples of the planar heating sheet according to the present invention.

FIG. 12 is a view for explaining a planar heating sheet according to a second embodiment of the present invention.

FIG. 13 is a view for explaining a planar heating sheet according to a third embodiment of the present invention.

FIG. 14 is a view for explaining a planar heating sheet according to a fourth embodiment of the present invention.

FIG. 15 is a photograph showing a general house vinyl made of polypropylene (PP), which is a base substrate, and FIG. 16 is a photograph showing the planar heating sheet according to the present invention.

FIG. 17 is an image view showing the exothermic reaction characteristics of the planar heating sheet according to Example 2,

FIG. 18 is an image view showing the exothermic reaction characteristics of the planar heating sheet according to Comparative Example 3,

FIG. 19 is an image view showing the exothermic reaction characteristics of the planar heating sheet according to Comparative Example 4, and

FIG. 20 is an image view showing the exothermic reaction characteristics of the planar heating sheet according to Comparative Example 5.

FIG. 21 is a graph showing the resistance characteristics of the planar heating sheets according to Example 2 and Comparative Examples 4 and 5.

FIG. 22 is a graph showing the measured transmittance of Example 2 and Comparative Examples 3 to 5.

FIG. 23 is a photograph showing a case where a first organic compound layer made of dopamine is formed on a base substrate, and FIG. 24 is a photograph showing a case where a first organic compound layer made of polydopamine is formed on a base substrate.

FIG. 25 is an image view showing the exothermic reaction characteristics of the planar heating sheet according to Example 3.

### BEST MODE FOR INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims.

Hereinafter, specific contents for carrying out the present invention will be described in detail with reference to the accompanying drawings. Regardless of the drawings, like numbers refer to like elements throughout. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present invention.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Unless defined otherwise, all terms (including technical and scientific terms) used in the description could be used as meanings commonly understood by those ordinary skilled in the art to which the present invention belongs. In addition, terms that are generally used but are not defined in the dictionary are not interpreted ideally or excessively unless they have been clearly and specially defined.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Hereinafter, preferred embodiments of the present invention will be described in detail with reference to the accompanying drawings.

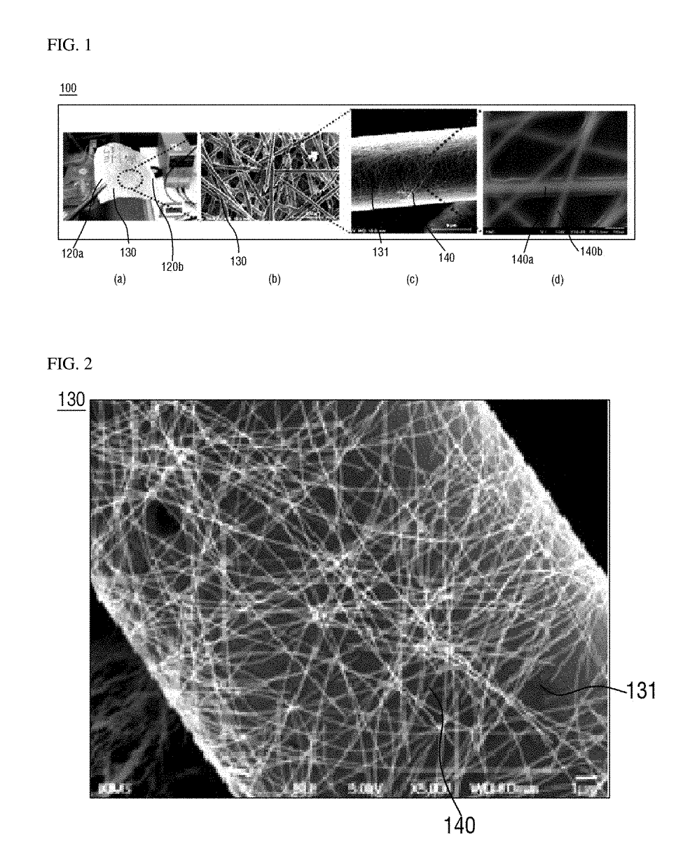

FIG. 1 is a view for explaining a planar heating sheet according to a first embodiment of the present invention.

Referring to FIG. 1, a planar heating sheet 100 according to a first embodiment includes a plurality of linear heating members 130, and includes a first electrode 120a connected to one side of the plurality of linear heating members 130 and a second electrode 120b connected to the other side of the plurality of linear heating members 130.

In this case, the present invention is characterized in that the plurality of linear heating members 130 are irregularly arranged.

That is, for example, the first linear heating member and the second linear heating member are arranged in an irregular form, not regularly woven, and the plurality of linear heating members are irregularly connected to each other. Details will be described later.

The first electrode and the second electrode may be made of a general metal material, and the metal material may be at least one of nickel (Ni), a nickel-phosphorus (Ni—P) alloy, a nickel-boron (Ni—B) alloy, a nickel-gold alloy (Ni—Au) alloy, gold (Au), and copper (Cu). However, in the present invention, the material of the first electrode and the second electrode is not limited thereto.

The planar heating sheet 100 according to the present invention may further include a power supply unit (not shown) for applying a power to the first electrode and the second electrode. That is, the power applied from the power supply unit (not shown) is applied to the first electrode and the second electrode, and is applied to the linear heating member connected to the first electrode and the second electrode, and, thereby, the linear heating member 130 may generate heat.

Meanwhile, although not shown in the drawings, the planar heating sheet according to the present invention may further include a base substrate (not shown) for supporting the linear heating member 130.

That is, in the present invention, although the planar heating sheet can serve as a planar heating sheet even without the base substrate, it is possible to support the linear heating member by further including the base substrate.

In this case, the base substrate (not shown) may be composed of a rigid or flexible support structure such as glass, plastic, paper, or fiber. However, in the present invention, the presence or absence of the base substrate is not limited.

Hereinafter, the linear heating member 130 according to the present invention will be described in more detail.

FIG. 2 is an enlarged photograph of the linear heating member 130 according to the present invention.

Referring to FIGS. 1 and 2, the linear heating member 130 according to the present invention includes a single fiber body 131 and a plurality of heating wires 140 surrounding the single fiber body 131.

That is, the linear heating member 130 according to the present invention may be configured such that the plurality of heating wires 140 are irregularly arranged on the surface of the single fiber body 131 of one strand, and the plurality of hotwires 140 surround the surface of the single fiber body 131.

In this case, the single fiber body 131 may use a general fiber, and the diameter of the single fiber body 131 may be several tens of micrometers to several hundreds of micrometers, for example, 10 to 500 μm.

Meanwhile, the length of the single fiber body 131 may be varied, and an appropriate length may be used according to the size of the planar heating sheet of the present invention.

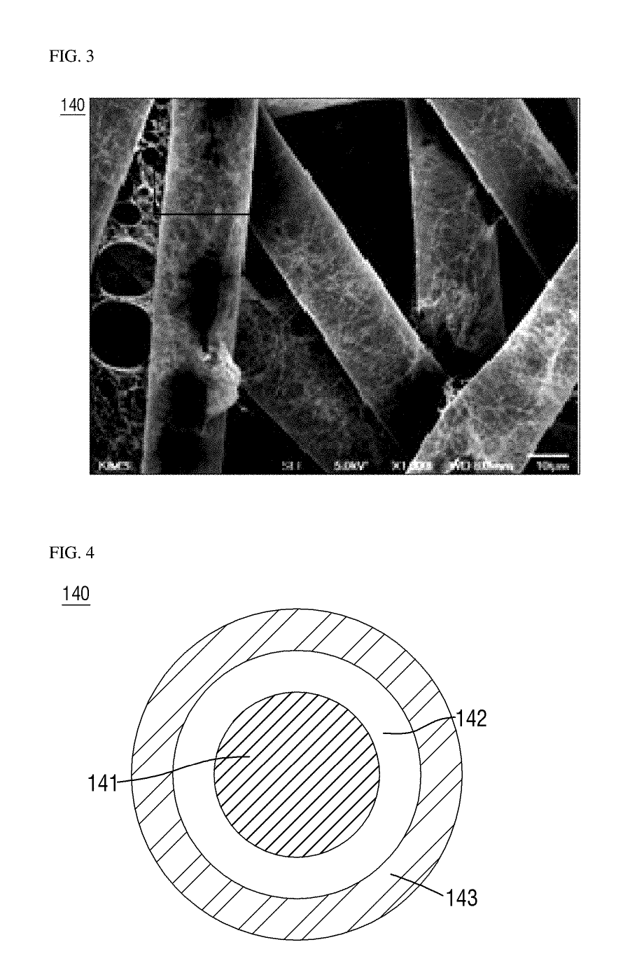

FIG. 3 is an enlarged photograph of the plurality of heating wires according to the present invention, and FIG. 4 is a sectional view taken along the line I-I of FIG. 3.

Referring to FIGS. 1, 3 and 4, the heating wire 140 according to the present invention includes a metal nanowire 141; an organic compound layer 142 applied on the metal nanowire 141; and a metal oxide layer 143 applied on the organic compound layer 142.

The metal nanowire 141 may be made of a metal such as gold (Au), silver (Ag), copper (Cu), aluminum (Al), platinum (Pt), or nickel (Ni). In the present invention, the metal nanowire 141 is preferably a silver (Ag) nanowire.

In this case, the diameter of the metal nanowire 141 may be 30 to 50 nm, and the length of the metal nanowire 141 may be 10 to 50 μm.

When the length of the metal nanowire is shorter than 10 μm, the conductivity of the metal nanowire may be insufficient. When the length of the metal nanowire is longer than 50 μm, it may be difficult for the metal nanowire to surround the single fiber body. Therefore, in the present invention, the length of the metal nanowire 141 is preferably 10 to 50 μm.

The organic compound layer 142 is used to prevent the oxidation of the metal nanowire and to improve the waterproof properties of the planar heating sheet according to the present invention. The organic compound layer 142 may be formed using catecholamine or a derivative thereof.

The “catecholamine” refers to a single molecule having a hydroxyl group (—OH) as an ortho-group of a benzene ring and various alkylamines as a para-group of the benzene ring.

The catecholamine may be synthesized in various forms depending on the choice of a precursor material. For example, catecholamine may be selected from the group consisting of dopamine, dopamine-quinone, alpha-methyldopamine, norepinephrine, epinephrine, alpha-methyldopa, droxidopa, and 5-hydroxydopamine. Preferably, the organic compound layer 142 may be made of dopamine (C₈H₁₁NO₂).

Meanwhile, the organic compound layer 142 not only can improve the junction characteristics between the nanowires, but also can serve as a mechanical support with intervening between the nanowire and the fiber body.

In addition, the organic compound layer can improve the junction characteristics of the metal oxide applied in the subsequent step.

As a result, the junction characteristics between the nanowire and the nanowire, between the nanowire and the fiber body and between the nanowire and the metal oxide are improved, and thus the electrical characteristics of the entire heating element can be improved.

Meanwhile, the dopamine can also serve as an electric channeling, thereby further improving the electrical characteristics of the heating element. In relation to waterproof properties, since the dopamine can endure high temperature, the dopamine can maintain waterproof properties even if temperature rises due to heat generation. Therefore, in the present invention, it is preferable that the organic compound layer 142 is made of dopamine (C₈H₁₁NO₂).

The waterproof properties are related to the water resistance of the planar heating sheet. That is, when the planar heating sheet is applied to a product, the waterproof properties are improved, so that damage of the product due to the penetration of moisture can be prevented, and therefore, the water resistance of the planar heating sheet can be improved.

The metal oxide layer 143 serves to improve the conductivity of the heating wire, and may be made of at least one selected from the group consisting of silicon (Si) oxide, titanium (Ti) oxide, zirconium (Zr) oxide, strontium (Sr) oxide, zinc oxide, indium oxide, lanthanum oxide, vanadium (Mo) oxide, tungsten (W) oxide, tin (Sn) oxide, niobium (Nb) oxide, magnesium (Mg) oxide, aluminum (Al) oxide, yttrium (Y) oxide, scandium (Sc) oxide, samarium (Sm) oxide, gallium (Ga) oxide, and strontium titanium (SrTi) oxide. Preferably, the metal oxide layer 143 is made of molybdenum (Mo) oxide or tungsten (W) oxide. However, in the present invention, the kind of the oxide is not limited.

In addition, the metal oxide layer 143 may be applied on the metal nanowire to prevent the oxidation of the metal nanowire, and may serve as an adhesive at a junction between the metal nanowire and the metal nanowire.

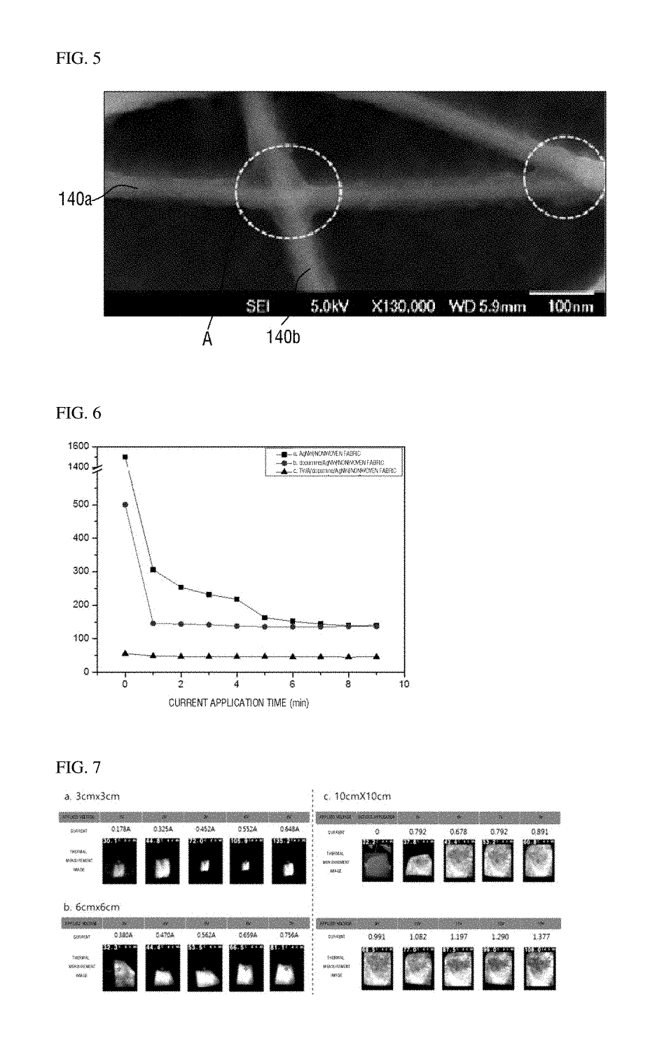

FIG. 5 is a photograph showing a junction between a metal nanowire and a metal nanowire.

As shown in FIG. 5, the junction A between the metal nanowire 140a and the metal nanowire 140b is a cause of resistance, and also corresponds to a site that causes a short circuit in a bending process.

Therefore, in the present invention, the metal oxide layer is formed on the organic compound layer, thereby improving the conductivity of the heating wire and improving the adhesion characteristics at the junction between the metal nanowires.

Summarizing these, the planar heating sheet 100 according to the first embodiment of the present invention includes a plurality of linear heating members irregularly arranged, each of the linear heating members includes a single fiber body 131 and a plurality of heating wires 140 surrounding the single fiber body 131, and each of the heating wire 140 includes a metal nanowire 141, an organic compound layer 142 applied on the metal nanowire, and a metal oxide layer 143 applied on the organic compound layer 142.

Further, the planar heating sheet 100 further includes a first electrode 120a connected with one side of the plurality of linear heating members 130 and a second electrode 120b connected with the other side of the plurality of linear heating members 130. The heating wire 140 may generate heat by applying a power to the first electrode 120a and the second electrode 120b.

As described above, a conventional planar heating sheet is formed as a rigid body because its heating wires are coated with a thermal resin or the like. Therefore, this conventional planar heating sheet is limited in use because it cannot be naturally folded or bent like a general fabric.

However, in the present invention, since the planar heating sheet is realized through a plurality of linear heating members each formed by coating a single fiber body with heating wires 140 each including a metal nanowire 141, an organic compound layer 142 applied on the metal nanowire, and a metal oxide layer 143 applied on the organic compound layer, this planar heating sheet can be naturally folded or bent like a general woven fabric, and thus can be used in a wide range.

For example, in the present invention, a single fiber body is coated with the above-mentioned heating wire, and the single fiber body coated with the heating wire, that is, the linear heating member is woven to be able to be used as a general fabric. Therefore, since the planar heating sheet of the present invention can maintain flexible characteristics, the use range thereof is very wide.

Further, for example, in the present invention, the linear heating members are irregularly arranged on a base substrate to be able to be used as a planar heating sheet. In this case, it is possible to realize a flexible planar heating sheet depending on the material of the base substrate.

Hereinafter, the present invention will be described in more detail with reference to Examples and Comparative Examples. However, the following examples are set forth only to illustrate the invention, and the scope of the invention is not limited to these examples.

### Example 1

First, a fiber body was coated with metal nanowires.

As the fiber body, a commercially available nonwoven fabric. Meanwhile, as pretreatment for removing impurities on the nonwoven fabric, the nonwoven fabric can be used after immersing the nonwoven fabric in acetone for 24 hours and drying the nonwoven fabric in an oven at 40° C. for 5 hours.

Ag nanowires were used as the metal nanowires. As the Ag nanowires, an Ag nanowire-dispersed solution purchased from NanoPix, Inc. was used. In the Ag nanowire-dispersed solution, the Ag nanowires had a thickness of 25 to 40 nm, a length of about 25 μm, and a concentration of 0.5 wt %. In this case, isopropyl alcohol (IPA) was used as a solvent.

For uniform and clean coating, the Ag nanowire-dispersed solution was diluted 5-fold to 10-fold with a mixed IPA:MeOH solution, and was applied by spin coating at 1000 rpm to coat the fiber body with the metal wires.

In the spin coating method, 4 ml of the solution based on a fiber substrate of 100×100 (mm) was sprayed for 3 seconds at 500 rpm, followed by 30 seconds at 1000 rpm. Then, the solution was naturally dried or dried by dryer. This procedure was repeated three times.

Meanwhile, a dip coating method may be used in addition to the spin coating method. In the dip coating method, the nonwoven fabric may be pushed down into a chalet containing a solution (30 ml of silver nanowire diluted solution), moved back and forth twice, and then slowly drawn out in one direction and dried. Meanwhile, the coating can be performed by various methods such as spraying, slot die, and the like in addition to spin coating. After the coating, natural drying was performed without heat treatment. However, in order to improve the mass production speed of a product, hot air drying at lower than 50° C. can also be performed.

Next, an organic compound layer was formed on the metal nanowire applied on the fiber body. Dopamine was used as an organic compound. 2 mg of dopamine was dispersed in 10 ml of MeOH to obtain a dopamine solution, and this dopamine solution was applied on the metal nanowire applied on the fiber body by dropping and spin coating.

In the case of spin coating, 4 ml of dopamine, based on a fiber substrate of 100×100 (mm), was dropped and applied at 1000 rpm for 30 seconds. After the coating, natural drying was performed without heat treatment. However, in order to improve the mass production speed of a product, hot air drying at lower than 50° C. can also be performed.

Meanwhile, a dip coating method may be used in addition to the spin coating method. In the dip coating method, similarly to the silver solution, the fiber body coated with the silver nanowire may be pushed down into a chalet containing the dopamine solution (40 ml), moved back and forth twice, and then slowly drawn out in one direction and dried by natural drying or a dryer. Next, a metal oxide layer was formed on the organic compound layer. In a metal oxide precursor solution, an alcohol-based solvent (anhydrous methanol or isopropyl alcohol) in which phosphomolybdic acid or phosphotungstic acid is dissolved was used. The metal oxide precursor solution was prepared by dissolving 1 to 5 mg of a solute per 1 ml of a solvent.

The coating of the organic compound layer with the metal oxide precursor solution can be performed in the air using a coating method, such as spin coating, dip coating, spraying, or slot die.

In the case of spin coating, 4 ml of the metal oxide precursor solution, based on a fiber substrate of 100×100 (mm), was dropped and applied at 3000 rpm for 30 seconds to form a metal oxide film having a thickness of about 10 to 20 nm.

Further, in the case of dip coating, similarly to the silver solution, the fiber body coated with dopamine may be pushed down into a chalet containing the metal oxide precursor solution (40 ml), moved back and forth twice, and then slowly drawn out in one direction and dried by natural drying or a dryer.

Further, when phosphomolybdic acid or phosphotungstic acid is used, MoOx (molybdenum oxide) or WOx (tungsten oxide) may be formed.

In this case, as described above, the metal oxide layer may be applied on the metal nanowire to prevent the oxidation of the metal nanowire, and may serve as an adhesive at the junction between the metal nanowire and the metal nanowire.

Meanwhile, generally, in the process of applying ZnO-based metal oxide using dry or wet process, high-temperature heat treatment is additionally required.

However, when applying metal oxide such as MoOx (molybdenum oxide) or WOx (tungsten oxide) using phosphomolybdic acid or phosphotungstic acid, it is possible to realize the role of a protective film or an adhesive only by drying at room temperature or by low-temperature drying by heat treatment at lower than 50° C. Therefore, the present invention is also applicable to materials vulnerable to high temperatures such as paper, plastic, vinyl, and the like.

The linear heating members 130 prepared in this way were irregularly arranged on the base substrate, and then the first electrode and the second electrode were disposed, so as to manufacture the planar heating sheet according to the present invention.

The above-described processes were carried out at room temperature/atmosphere, and no additional heat treatment was carried out.

However, current annealing may be performed after performing the entire process of forming up to the metal oxide layer. That is, a pulse current may be applied to the first electrode and the second electrode as described above to replace additional separate heat treatment.

In order to apply the pulse current, current annealing was carried out by repeating the process of turning ON a current of 100 mA for 1 minute and turning OFF the current for 30 seconds 10 times.

That is, an additional heat treatment process can be omitted by merely performing the current annealing utilizing the first electrode and the second electrode included in the planar heating sheet according to the present invention.

### Comparative Example 1

A fiber body was coated with only a metal nanowire. That is, Comparative Example 1 was carried out in the same manner as in Example 1, except that an organic compound layer and a metal oxide layer were not formed.

### Comparative Example 2

A fiber body was coated with only a metal nanowire, and an organic compound layer was formed on the metal nanowire. That is, Comparative Example 2 was carried out in the same manner as in Example 1, except that a metal oxide layer was not formed.

FIG. 6 is a graph showing the resistance characteristics of the planar heating sheets according to Example 1 and Comparative Examples 1 and 2. In FIG. 6, a indicates Comparative Example 1, b indicates Comparative Example 2, and c indicates Example 1. In FIG. 6, the current application time means the current annealing through application of the above-described pulse current.

Referring to FIG. 6, in the case of Example 1 where the metal nanowire is coated with the organic compound layer and the metal oxide layer, it can be ascertained that resistance is very low, compared to Comparative Example 1 where the heating member is composed of only the metal nanowire and Comparative Example 2 where the metal nanowire is coated with the organic compound layer.

Meanwhile, in FIG. 6, it can be ascertained that the resistance characteristics when the current is applied (1 min) and when the current is not applied (0 min) are different from each other. That is, in the present invention, it can be ascertained that even if an additional heat treatment process is excluded, the heat treatment process can be replaced only by the current annealing through the application of a pulse current.

FIG. 7 is an image view showing the exothermic characteristics of the planar heating sheet according to Example 1.

Referring to FIG. 7, it can be ascertained that the temperature of the planar heating sheet increases for each test piece size depending on the applied voltage and current. For example, in the case of a test piece having a size of 10 cm×10 cm, it can be ascertained that the temperature of the test piece can increase up to 68.5° C. even by the application of a voltage of 9 V and a current of 0.991 A, and that the temperature thereof can increase up to 108.0° C. by the application of a voltage of 13 V and a current of 1.377 A.

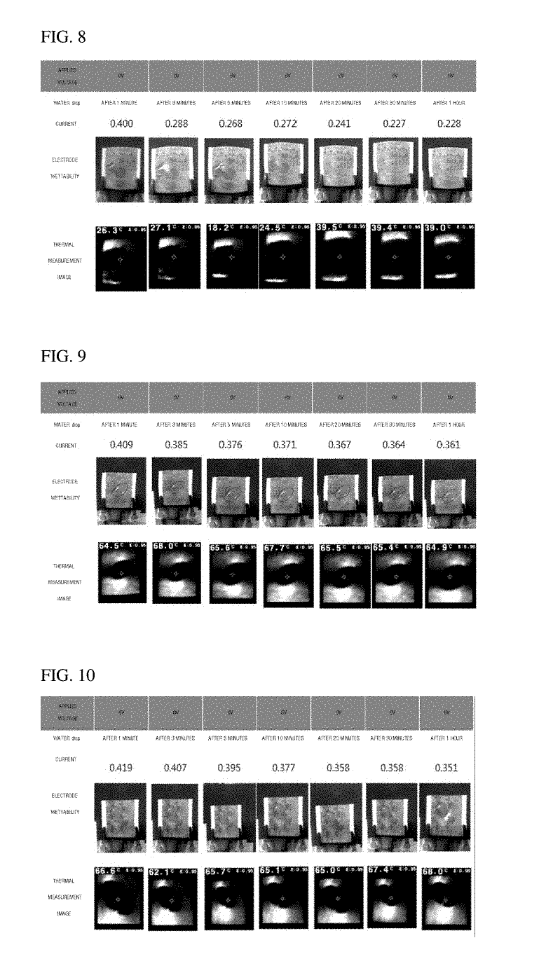

FIG. 8 is a view showing the results of a water resistance test according to Comparative Example 1, FIG. 9 is a view showing the results of a water resistance test according to Comparative Example 2, and FIG. 10 is a view showing the results of a water resistance test according to Example 1.

First, referring to FIG. 8, in the case of Comparative Example 1 in which the heating member is composed of the metal nanowire, as can be seen from the electrode wettability image, it can be ascertained that water is gradually absorbed and spread widely over time, which can be confirmed by thermal measurement images.

As a result, it can be ascertained that a product is damaged by the absorption of water in the planar heating sheet.

Next, referring to FIGS. 9 and 10, in the case of Comparative Example 2 where the metal nanowire is coated with only the organic compound layer and Example 1 where the metal wire is coated with the organic compound layer and the metal oxide layer, that is, in the case where the metal wire is coated with the organic compound layer made of dopamine, it can be ascertained that water droplets are not absorbed and still remain as large droplets despite 1 hour passed, which can be confirmed by thermal measurement images.

This means that dopamine has a great effect in preventing the absorption of water to increase water resistance. As a result, it can be confirmed that no water is absorbed into the planar heating sheet, and thus a product is not damaged.

As described above, since the planar heating sheet is realized through a plurality of linear heating members each formed by coating a single fiber body with heating wires, each including a metal nanowire 141, an organic compound layer 142 applied on the metal nanowire 141, and a metal oxide layer 143 applied on the organic compound layer 142, this planar heating sheet can be naturally folded or bent like a general woven fabric, and thus can be used in a very wide range.

FIG. 11 is a photograph showing application examples of the planar heating sheet according to the first embodiment of the present invention.

Referring to FIG. 11, the planar heating sheet according to the first embodiment of the present invention can be used as □ a detachable ultra slim sheet-type wall surface heater, and a consumer can freely select the size/design thereof. Further, this planar heating sheet can be used as □ a USB type mini heating pad, and can also be applied to portable (such as clothes/mobile phones) and stationary (desks/chairs) mini pads. Further, this planar heating sheet can be used for □ preventing the activity of microbes in the fungus soil and the frost of a house, and can be applied to agricultural fields requiring low temperature and water repellency. Further, this planar heating sheet can be used as \textcircled{4} a curved surface heater having maximized flexibility, and can be applied to a special type curved surface heater.

Further, due to the above heating wire structure, that is, a structure including a metal nanowire 141, an organic compound layer 142 applied on the metal nanowire 141, and a metal oxide layer 143 applied on the organic compound layer 142, the resistance of the heating wire can be lowered, and thus high exothermic characteristics can be realized even by applying a low current.

Further, in the heating wire structure, for example, a nanowire is coated with an organic compound layer made of dopamine, so that the waterproof properties of the heating wire can be improved, thereby improving the durability of the planar heating sheet.

Further, the application of the metal oxide layer can provide electrical resistance reduction, a protective film, an adhesive, and anti-oxidation properties. In particular, unlike a conventional heating wire structure, a thin film of several nm can be formed by a room-temperature or low-temperature heat treatment process.

### MODE FOR INVENTION

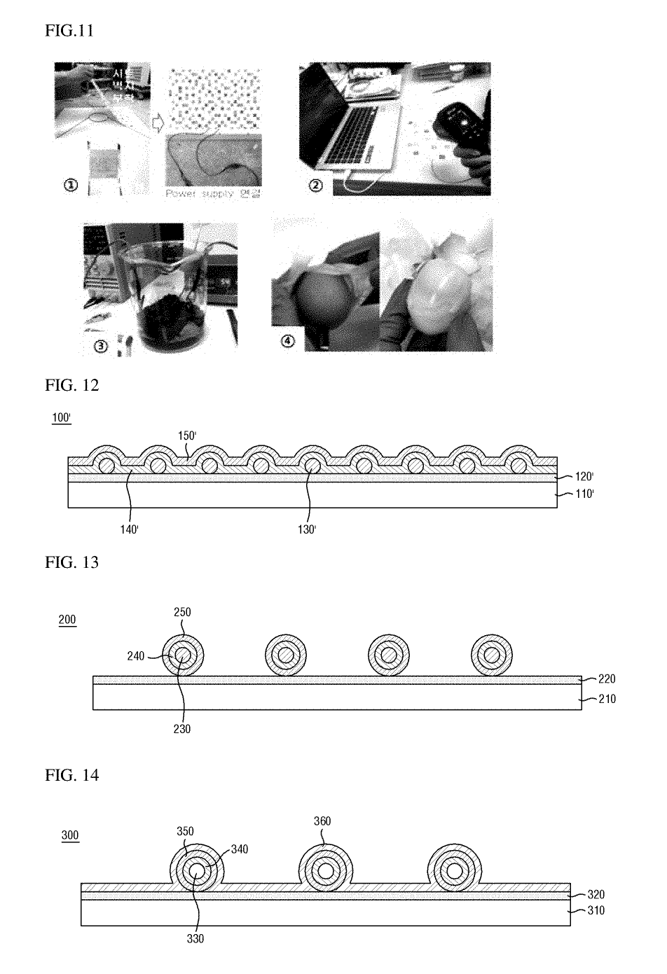

FIG. 12 is a view for explaining a planar heating sheet according to a second embodiment of the present invention.

Referring to FIG. 12, a planar heating sheet 100′ according to a second embodiment includes a base substrate 110′.

The base substrate 110′ is a structure for supporting a heating member to be described later, and may be made of a flexible material, such as vinyl, plastic, paper, or fiber.

In this case, in the present invention, the base substrate 110′ may be made of a vinyl material. More specifically, the vinyl material may be at least one material selected from the group consisting of polypropylene (PP), polyvinyl chloride (PVC), polyethylene (PE), and vinyl acetate (EVA).

However, in the present invention, the material of the base substrate is not limited.

The planar heating sheet 100′ according to the second embodiment includes a first organic compound layer 120′ disposed on the base substrate 110′.

The first organic compound layer 120′ may be formed using catecholamine or a derivative thereof.

The “catecholamine” refers to a single molecule having a hydroxyl group (—OH) as an ortho-group of a benzenering and various alkylamines as a para-group of the benzene ring.

The catecholamine may be synthesized in various forms depending on the choice of a precursor material. For example, catecholamine may be selected from the group consisting of dopamine, dopamine-quinone, alpha-methyldopamine, norepinephrine, epinephrine, alpha-methyldopa, droxidopa, and 5-hydroxydopamine. Preferably, the first organic compound layer 120′ may be made of dopamine (C₈H₁₁NO₂).

In this case, the first organic compound layer 120′ is used for improving the junction characteristics between a heating member to be described later and the base substrate 110′. Details will be described later.

Referring to FIG. 12 again, the planar heating sheet 100′ according to the second embodiment includes a heating member (130′, 140′, 150′) disposed on the first organic compound layer 120′.

The heating member according to the second embodiment of the present invention is defined as a planar heating member in that the heating member (130′, 140′, 150′) is disposed on the first organic compound layer 120′ in a plane.

Hereinafter, the heating member according to the second embodiment of the present invention will be described in more detail.

The heating member (130′, 140′, 150′) according to the second embodiment of the present invention includes metal wires 130′.

In this case, the diameter of the metal nanowire 130′ may be 30 to 50 nm, and the length of the metal nanowire 130′ may be 10 to 50 μm. However, in the present invention, the diameter and length of the metal nanowire 130′ are not limited.

The metal nanowire 130′ may be made of a metal such as gold (Au), silver (Ag), copper (Cu), aluminum (Al), platinum (Pt), or nickel (Ni). In the present invention, the metal nanowire 141 is preferably a silver (Ag) nanowire.

Meanwhile, in the present invention, the metal nanowires 130′ may be irregularly arranged.

That is, for example, the plurality of metal nanowires may be regularly arranged in a stripe manner on the first organic compound layer 120′. Unlike this, the plurality of metal nanowires are irregularly arranged on the first organic compound layer 120′, and thus the plurality of metal nanowires may be irregularly connected to each other on the first organic compound layer 120′.

Referring to FIG. 12 again, the heating member (130′, 140′, 150′) according to the second embodiment of the present invention includes a second organic compound layer 140′ disposed on the metal nanowires 130′.

The second organic compound layer 140′ may be formed using catecholamine or a derivative thereof.

The “catecholamine” refers to a single molecule having a hydroxyl group (—OH) as an ortho-group of a benzene ring and various alkylamines as a para-group of the benzene ring.

Since the second organic compound layer 140′ is the same as the aforementioned first organic compound layer 120′, a detailed description thereof will be omitted.

In this case, the meaning that the second organic compound layer 140′ is disposed on the metal nanowires 130′ means that the interface of the second organic compound layer 140′ and the interface of the first organic compound layer 120′ are in contact with each other while the second organic compound layer 140′ covers the metal nanowires 130′.

That is, as shown in the drawings, the second organic compound layer 140′ may be disposed on the metal nanowires 130′ in a state where the upper surface of the first organic compound layer 120′ and the lower surface of the second organic compound layer 140′ are in contact with each other.

Meanwhile, the second organic compound layer 140′ can first improve the junction characteristics between the metal nanowires, and can serve as a support for supporting the metal nanowires disposed on the first organic compound layer 120′ by the contact between the interface of the second organic compound layer 140′ and the interface of the first organic compound layer 120′.

In addition, the second organic compound layer 140′ can improve the junction characteristics of the metal oxide layer to be applied in a subsequent step.

As a result, the second organic compound layer 140′ improves the junction characteristics between the metal nanowire and the metal nanowire, between the metal nanowire and the first organic compound layer, and between the metal nanowire and the metal oxide layer, so as to improve the electrical characteristics of the entire planar heating sheet.

Meanwhile, the dopamine can also serve as an electric channeling, thereby further improving the electrical characteristics of the metal nanowires. In relation to waterproof properties, since the dopamine can endure high temperature, the dopamine can maintain waterproof properties even if temperature rises due to heat generation. Therefore, in the present invention, it is preferable that the organic compound layer 142 is made of dopamine (C₈H₁₁NO₂).

The waterproof properties are related to the water resistance of the planar heating sheet. That is, when the planar heating sheet is applied to a product, the waterproof properties are improved, so that damage of the product due to the penetration of moisture can be prevented, and therefore, the water resistance of the planar heating sheet can be improved.

Referring to FIG. 12 again, the heating member (130′, 140′, 150′) according to the second embodiment of the present invention includes a metal oxide layer 150′ disposed on the second organic compound layer 140′.

The metal oxide layer 150′ serves to improve the conductivity of the metal nanowires, and may be made of at least one selected from the group consisting of silicon (Si) oxide, titanium (Ti) oxide, zirconium (Zr) oxide, strontium (Sr) oxide, zinc oxide, indium oxide, lanthanum oxide, vanadium (Mo) oxide, tungsten (W) oxide, tin (Sn) oxide, niobium (Nb) oxide, magnesium (Mg) oxide, aluminum (Al) oxide, yttrium (Y) oxide, scandium (Sc) oxide, samarium (Sm) oxide, gallium (Ga) oxide, and strontium titanium (SrTi) oxide. Preferably, the metal oxide layer 143 is made of molybdenum (Mo) oxide or tungsten (W) oxide. However, in the present invention, the kind of the oxide is not limited.

In addition, the metal oxide layer 150′ may be applied on the metal nanowires to prevent the oxidation of the metal nanowires, and may serve as an adhesive at the junction between the metal nanowire and the metal nanowire.

As described above, the planar heating sheet according to the second embodiment of the present invention includes a base substrate 110′, a first organic compound layer 120′ disposed on the base substrate 110′, and a heating member, more specifically, a planar heating member, disposed on the first organic compound layer 120′.

In this case, the heating member may include metal nanowires 130′ disposed on the first organic compound layer 120′; a second organic compound layer 140′ disposed on the metal nanowires 130′; and a metal oxide layer 150′ disposed on the second organic compound layer 140′.

Further, in the present invention, the metal nanowires 130′ may be irregularly arranged. More specifically, the plurality of metal nanowires may be irregularly connected to each other on the first organic compound layer 120′.

Further, the second organic compound layer 140′ may be in a state where the interface of the second organic compound layer 140′ and the interface of the first organic compound layer 120′ are in contact with each other while the second organic compound layer 140′ covers the metal nanowires 130′.

Thus, the second organic compound layer 140′ can first improve the junction characteristics between the metal nanowires, and can serve as a support for supporting the metal nanowires disposed on the first organic compound layer 120′ by the contact between the interface of the second organic compound layer 140′ and the interface of the first organic compound layer 120′.

Meanwhile, although not shown in the drawings, the planar heating sheet according to the second embodiment of the present invention may include the heating member, more specifically, a first electrode (not shown) connected with one side of the metal oxide layer and the heating member, more specifically, a second electrode (not shown) disposed to face the first electrode and connected with the other side of the metal oxide layer.

The first electrode and the second electrode may be made of a general metal material, and the metal material may be at least one of nickel (Ni), a nickel-phosphorus (Ni—P) alloy, a nickel-boron (Ni—B) alloy, a nickel-gold alloy (Ni—Au) alloy, gold (Au), and copper (Cu). However, in the present invention, the material of the first electrode and the second electrode is not limited thereto.

The planar heating sheet 100′ according to the present invention may further include a power supply unit (not shown) for applying power to the first electrode and the second electrode. That is, power is applied to the first electrode and the second electrode from the power source unit (not shown), and the power is applied to the linear heating member connected to the first electrode and the second electrode, and, thereby, the linear heating member 130 can generate heat.

FIG. 13 is a view for explaining a planar heating sheet according to a third embodiment of the present invention. Hereinafter, the planar heating sheet according to the third embodiment of the present invention may refer to the aforementioned second embodiment except for the following contents.

Referring to FIG. 13, a planar heating sheet 200 according to a third embodiment includes a base substrate 210.

The base substrate 210 is a structure for supporting a heating member to be described later, and may be made of a flexible material, such as vinyl, plastic, paper, or fiber. Since this base substrate is the same as that in the second embodiment, a detailed description thereof will be omitted.

The planar heating sheet 200 according to the third embodiment includes a first organic compound layer 220 disposed on the base substrate 210.

The first organic compound layer 220 may be formed using catecholamine or a derivative thereof. Since this first organic compound layer is the same as that in the second embodiment, a detailed description thereof will be omitted.

Referring to FIG. 13 again, the planar heating sheet 200 according to the third embodiment of the present invention includes a heating member (230, 240, 250) disposed on the first organic compound layer 220.

The heating member according to the third embodiment of the present invention is defined as a linear heating member in that the heating member (230, 240, 250) is disposed on the first organic compound layer 120′ in a line.

That is, comparing the third embodiment with the aforementioned second embodiment, in the second embodiment, the heating member is disposed on the first organic compound layer in a plane, whereas, in the third embodiment, the heating member to be described later is disposed on the first organic compound layer in a line. From this point, in order to distinguish these heating members, the heating member according to the third embodiment of the present invention may be defined as a linear heating member.

However, in the present invention, the meanings of the “linear heating member” and the “planar heating member” are not limited.

Hereinafter, the heating member according to the third embodiment of the present invention will be described in more detail.

Referring to FIG. 13, the heating member (230, 240, 250) according to the third embodiment of the present invention includes a metal nanowire 230.

In this case, the diameter of the metal nanowire 230 may be 30 to 50 nm, and the length of the metal nanowire 230 may be 10 to 50 μm. However, in the present invention, the diameter and length of the metal nanowire 230 are not limited. Since this is the same as described above, a detailed description thereof will be omitted.

The heating member (230, 240, 250) according to the third embodiment of the present invention includes a second organic compound layer 240 disposed on the metal nanowire 230.

The second organic compound layer 240 may be formed using catecholamine or a derivative thereof. Since the second organic compound layer 240 is the same as the aforementioned first organic compound layer 220, a detailed description thereof will be omitted.

In this case, in the third embodiment of the present invention, the meaning that the second organic compound layer 230 is disposed on the metal nanowire 230 may mean that the second organic compound layer 230 is disposed to surround the outer surface of the metal nanowire 230.

That is, in the aforementioned second embodiment, since the second organic compound layer corresponds to a state where the interface of the second organic compound layer and the interface of the first organic compound layer are in contact with each other while the second organic compound layer covers the metal nanowire, a part of the metal nanowire is in contact with the first organic compound layer. However, in this third embodiment, since the second organic compound layer 230 is disposed to surround the outer surface of the metal nanowire 230, it can be confirmed that the metal nanowire is not in direct contact with the first organic compound layer 220.

The heating member (230, 240, 250) according to the third embodiment of the present invention includes a metal oxide layer 250 disposed on the second organic compound layer 240. Since the material of the metal oxide layer is the same as that in the second embodiment, a detailed description thereof will be omitted.

In this case, in the third embodiment of the present invention, the meaning that the metal oxide layer 250 is disposed on the second organic compound layer 240 may mean that the metal oxide layer 250 is disposed to surround the outer surface of the second organic compound layer 240.

That is, in the aforementioned second embodiment, the metal oxide layer is formed on the second organic compound layer, so that the interface of the second organic compound layer and the interface of the first organic compound layer are in contact with each other. However, in this third embodiment, since the metal oxide layer 250 is disposed to surround the outer surface of the second organic compound layer 240, the second organic compound layer 240 is not in contact with the first organic compound layer 220, but the outer surface of the metal oxide layer 250 is in contact with the interface of the first organic compound layer 220.

Meanwhile, in the third embodiment, the heating members (230, 240, 250) may be irregularly arranged.

That is, for example, the plurality of heating members (230, 240, 250) may be regularly arranged in a stripe manner on the first organic compound layer 220. Unlike this, the plurality of heating members (230, 240, 250) are irregularly arranged on the first organic compound layer 220, and thus the plurality of heating members (230, 240, 250) may be irregularly connected to each other on the first organic compound layer 220.

Meanwhile, although not shown in the drawing, the planar heating sheet according to the third embodiment of the present invention may include a first electrode connected with one side of the heating member and a second electrode disposed to face the first electrode and connected with the other side of the heating member.

Further, the planar heating sheet 200 according to the third embodiment of the present invention may further include a power supply unit (not shown) for applying a power to the first electrode and the second electrode. That is, the power applied from the power supply unit (not shown) is applied to the first electrode and the second electrode, and is applied to the heating member connected to the first electrode and the second electrode, and, thereby, the heating member 130 can generate heat.

Since this configuration is the same as that in the second embodiment, a detailed description thereof will be omitted.

As described above, the planar heating sheet 200 according to the third embodiment of the present invention includes a base substrate 210 and a first organic compound layer 220 disposed on the base substrate 210, and includes a heating member, more specifically, a linear heating member disposed on the first organic compound layer 220.

In this case, the heating member includes a metal nanowire 230; a second organic compound layer 240 disposed on the metal nanowire 230; and a metal oxide layer 250 disposed on the second organic compound layer 240.

Further, in the present invention, the plurality of heating members (230, 240, 250) may be regularly arranged. More specifically, the plurality of heating members (230, 240, 250) are arranged on the first organic compound layer 220 in an irregular form, and thus the plurality of heating members (230, 240, 250) may be irregularly connected to each other on the first organic compound layer 220.

Further, in the present invention, the second organic compound layer 240 may be disposed to surround the outer surface of the metal nanowire 230, and the metal oxide layer 250 may be disposed to surround the outer surface of the second organic compound layer 240.

Therefore, in this third embodiment, since the second organic compound layer 240 is disposed to surround the outer surface of the metal nanowire 230 and the metal oxide layer 250 is disposed to surround the outer surface of the second organic compound layer 240, the second organic compound layer 240 is not in contact with the first organic compound layer 220, but the outer surface of the metal oxide layer 250 is in contact with the interface of the first organic compound layer 220.

FIG. 14 is a view for explaining a planar heating sheet according to a fourth embodiment of the present invention. Hereinafter, the planar heating sheet according to the fourth embodiment of the present invention may refer to the aforementioned third embodiment except for the following contents.

Referring to FIG. 14, a planar heating sheet 300 according to a fourth embodiment includes a base substrate 310.

The planar heating sheet 300 includes a first organic compound layer 320 disposed on the base substrate 310, and includes a heating member disposed on the first organic compound layer 320. In this case, the heating member includes a metal nanowire 330; a second organic compound layer 340 disposed on the metal nanowire 330; and a metal oxide layer disposed on the second organic compound layer 340.

Since this configuration is the same as that in the third embodiment, a detailed description thereof will be omitted.

Referring to FIG. 14 again, the planar heating sheet according to the fourth embodiment of the present invention includes a third organic compound layer 360 disposed on the heating member (330, 340, 350).

The third organic compound layer 360 may be formed using catecholamine or a derivative thereof. Since this third organic compound layer 360 is the same as the aforementioned first organic compound layer 320, a detailed description thereof will be omitted.

In this case, the meaning that the third organic compound layer 360 is disposed on the heating member (330, 340, 350) means that the interface of the third organic compound layer 360 disposed on the heating member (330, 340, 350) and the interface of the first organic compound layer 320 are in contact with each other while the third organic compound layer 360 covers the heating member (330, 340, 350).

That is, as shown in the drawings, the third organic compound layer 360 may be disposed on the heating member (330, 340, 350) in a state where the upper surface of the first organic compound layer 320 and the lower surface of the third organic compound layer 360 are in contact with each other.

The third organic compound layer 360 can serve as a support for supporting the heating member (330, 340, 350) disposed on the first organic compound layer 320 by the contact between the interface of the third organic compound layer 360 and the interface of the first organic compound layer 320.

Meanwhile, although not shown in the drawing, the planar heating sheet according to the fourth embodiment of the present invention may include a first electrode connected with one side of the third organic compound layer and a second electrode disposed to face the first electrode and connected with the other side of the third organic compound layer.

Further, the planar heating sheet 300 according to the fourth embodiment of the present invention may further include a power supply unit (not shown) for applying power to the first electrode and the second electrode. That is, the power applied from the power supply unit (not shown) is applied to the first electrode and the second electrode, and is applied to the heating member connected to the first electrode and the second electrode through the third organic compound layer, and, thereby, the heating member 130 can generate heat.

Since this configuration is the same as that in the second embodiment, a detailed description thereof will be omitted.

As described above, the planar heating sheet according to the fourth embodiment of the present invention includes a base substrate 310 and a first organic compound layer 320 disposed on the base substrate 310, and includes a heating member, more specifically, a linear heating member disposed on the first organic compound layer 320.

In this case, the heating member includes a metal nanowire 330; a second organic compound layer 340 disposed on the metal nanowire 330; and a metal oxide layer 350 disposed on the second organic compound layer 340.

Further, in the present invention, the plurality of heating members (330, 340, 350) may be regularly arranged. More specifically, the plurality of heating members (330, 340, 350) are arranged on the first organic compound layer 320 in an irregular form, and thus the plurality of heating members (330, 340, 350) may be irregularly connected to each other on the first organic compound layer 320.

Further, in the present invention, the second organic compound layer 340 may be disposed to surround the outer surface of the metal nanowire 330, and the metal oxide layer 350 may be disposed to surround the outer surface of the second organic compound layer 340.

Therefore, in this fourth embodiment, since the second organic compound layer 340 is disposed to surround the outer surface of the metal nanowire 330 and the metal oxide layer 350 is disposed to surround the outer surface of the second organic compound layer 340, the second organic compound layer 340 is not in contact with the first organic compound layer 220, and the outer surface of the metal oxide layer 350 is in contact with the interface of the first organic compound layer 320.

Further, in this fourth embodiment, the planar heating sheet includes a third organic compound layer 360 disposed on the heating member (330, 340, 350), and the third organic compound layer 360 may be in a state where the interface of the third organic compound layer 360 and the interface of the first organic compound layer 320 are in contact with each other while the third organic compound layer 360 covers the heating member (330, 340, 350).

Therefore, in this fourth embodiment, the third organic compound layer 360 can serve as a support for supporting the heating member (330, 340, 350) disposed on the first organic compound layer 320 by the contact between the interface of the third organic compound layer 360 and the interface of the first organic compound layer 320.

As described above, a conventional planar heating sheet is formed into a rigid body because the outer surface of a heating wire is coated with a thermal resin. Therefore, this planar heating sheet is limited in use because it cannot be naturally folded or bent.

However, since the heating sheet of the present invention is realized by a planar heating member or a linear heating member including a metal nanowire, a second organic compound layer disposed on the metal nanowire, and a metal oxide layer disposed on the second organic compound layer and formed on a base substrate which is a support structure made of a flexible material such as vinyl, plastic, paper, fiber, or the like, this heating sheet can be naturally folded or bent, and thus is very wide in usage.

Hereinafter, the present invention will be described in more detail with reference to Examples and Comparative Examples. However, the following examples are set forth only to illustrate the invention, and the scope of the invention is not limited to these examples.

### Example 2

A general house vinyl (100×100 mm²) made of polypropylene (PP) was prepared as a base substrate. The base substrate was pretreated, and the pretreatment process was carried out by dipping the base substrate into isopropyl alcohol (IPA) for 1 minute, drying the base substrate through a hot air dryer, and then performing ozone treatment for 5 minutes. However, the pretreatment process may not be carried out.

A first organic compound layer was formed on the pretreated vinyl base substrate. As the material of the first organic compound layer, dopamine was used. The first organic compound layer was formed on the base substrate by a dip-sliding method. Specifically, a dopamine solution (in which 6 mg of dopamine hydrochloride was dissolved in 30 ml of MeOH) was put into a bath (12×12×1.7 cm³), and the pretreated vinyl base substrate was dipped into the dopamine solution.

Next, metal nanowires were formed on the first organic compound layer. Ag nanowires were used as the metal nanowires. As the Ag nanowires, an Ag nanowire-dispersed solution purchased from NanoPix, Inc. was used. In the Ag nanowire-dispersed solution, the Ag nanowires had a thickness of 25 to 40 nm, a length of about 25 μm, and a concentration of 0.5 wt %. In this case, isopropyl alcohol (IPA) was used as a solvent. Meanwhile, for uniform and clean coating, the Ag nanowire-dispersed solution may be diluted 5-fold to 10-fold with a mixed IPA:MeOH solution. In this case, the first organic compound layer was coated with the metal nanowires by a dip coating method.

In the dip coating method, the base substrate including the first organic compound layer may be pushed down into a chalet containing a solution (30 ml of silver nanowire diluted solution: AgNW (5.45 ml), IPA (12.27 ml), MeOH (12.27 ml)), moved back and forth twice, and then slowly drawn out in one direction and dried.

Meanwhile, the coating can be performed by various methods such as spin coating, spraying, slot die, and the like in addition to dip coating. After the coating, natural drying was performed without heat treatment. However, in order to improve the mass production speed of a product, hot air drying at lower than 50° C. can also be performed.

Next, a second organic compound layer was formed on the metal nanowires. As the material of the second organic compound layer, dopamine was used. The second organic compound layer was formed on the metal nanowires by a dip-sliding method. Specifically, a dopamine solution (in which 2 mg of dopamine hydrochloride was dissolved in 10 ml of MeOH) was put into a bath (12×12×1.7 cm³), and the base substrate including the metal nanowires was dipped into the dopamine solution.

Next, a metal oxide layer was formed on the second organic compound layer. In a metal oxide precursor solution, an alcohol-based solvent (anhydrous methanol or isopropyl alcohol) in which phosphotungstic acid (TWA) is dissolved was used. In the metal oxide precursor solution, 75 mg of phosphotungstic acid hydrate was dispersed in 30 ml of MeOH.

The coating of the organic compound layer with the metal oxide precursor solution can be performed in the air using a coating method, such as spin coating, dip coating, spraying, or slot die.

In the case of spin coating, 4 ml of the metal oxide precursor solution, based on 100×100 (mm), was dropped and applied at 3000 rpm for 30 seconds to form a metal oxide film having a thickness of about 10 to 20 nm.

Further, in the case of dip coating, similarly to the silver solution, the fiber body coated with dopamine may be pushed down into a chalet containing the metal oxide precursor solution (40 ml), moved back and forth twice, and then slowly drawn out in one direction and dried by natural drying or a dryer.

Further, when phosphomolybdic acid or phosphotungstic acid is used, MoOx (molybdenum oxide) or WOx (tungsten oxide) may be formed.

In this case, as described above, the metal oxide layer may be applied on the metal nanowire to prevent the oxidation of the metal nanowire, and may serve as an adhesive at the junction between the metal nanowire and the metal nanowire.

Meanwhile, generally, in the process of applying ZnO-based metal oxide using dry or wet process, high-temperature heat treatment is additionally required.

However, when applying metal oxide such as MoOx (molybdenum oxide) or WOx (tungsten oxide) using phosphomolybdic acid or phosphotungstic acid, it is possible to realize the role of a protective film and an adhesive only by drying at room temperature or by low-temperature drying by heat treatment at lower than 50° C. Therefore, the present invention is also applicable to materials vulnerable to high temperatures such as paper, plastic, vinyl, and the like.

Then, a first electrode and a second electrode were disposed on the base substrate including the metal oxide layer formed in this way, so as to manufacture the planar heating sheet according to the present invention.

That is, in the case of Example 2, the planar heating sheet corresponds to a laminate structure of vinyl/dopamine/AgNW/dopamine/TWA.

The above-described processes were carried out at room temperature/atmosphere, and no additional heat treatment was carried out.

However, current annealing can be performed after performing the entire process of forming up to the metal oxide layer. That is, a pulse current may be applied to the first electrode and the second electrode as described above to replace additional heat treatment.

In order to apply the pulse current, the current annealing was carried out by repeating the process of turning ON a current of 100 mA for 1 minute and turning OFF the current for 30 seconds 10 times.

That is, an additional heat treatment process can be omitted by merely performing the current annealing utilizing the first electrode and the second electrode included in the planar heating sheet according to the present invention.

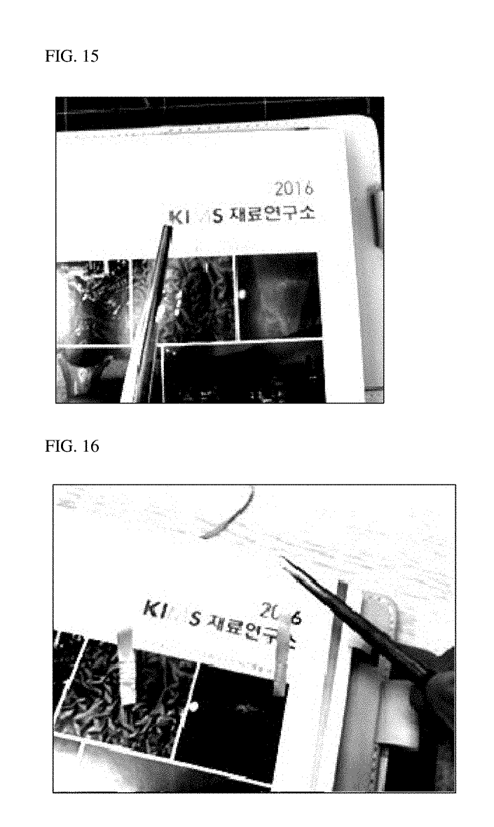

FIG. 15 is a photograph showing a general house vinyl made of polypropylene (PP), which is a base substrate, and FIG. 16 is a photograph showing the planar heating sheet according to the present invention.

As shown in FIGS. 15 and 16, it can be ascertained that the planar heating sheet according to the present invention exhibits the same transmittance and bending properties as a general house vinyl.

### Comparative Example 3

Comparative Example 3 was carried out in the same manner as Example 2, except that only silver nanowires were formed on a general house vinyl made of polypropylene (PP), which is a base substrate.

That is, in the case of Comparative Example 3, the heating sheet corresponds to the laminate structure of vinyl/AgNW.

### Comparative Example 4

Comparative Example 4 was carried out in the same manner as Example 2, except that a dopamine layer, which is a first organic compound layer, was formed on a general house vinyl made of polypropylene (PP), which is a base substrate, and only silver nanowires were formed on the first organic compound layer.

That is, in the case of Comparative Example 4, the heating sheet corresponds to the laminate structure of vinyl/dopamine/AgNW.

### Comparative Example 5

Comparative Example 5 was carried out in the same manner as Example 2, except that a dopamine layer, which is a first organic compound layer, was formed on a general house vinyl made of polypropylene (PP), which is a base substrate, silver nanowires were formed on the first organic compound layer, and a dopamine layer, which is a second organic compound layer, was formed on the silver nanowires.

That is, in the case of Comparative Example 5, the heating sheet corresponds to the laminate structure of vinyl/dopamine/AgNW/dopamine.

The exothermic reaction characteristics, resistance characteristics and transmittance characteristics of Example 2 and Comparative Examples 3 to 5 were measured.

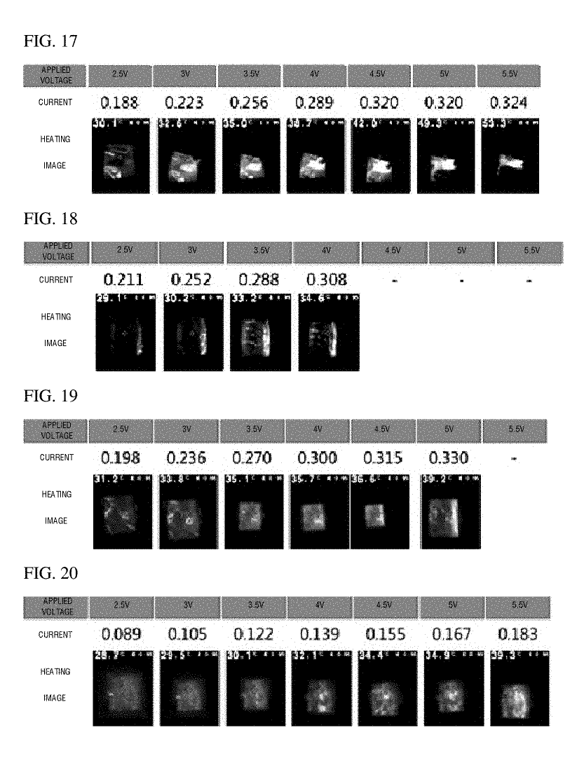

FIG. 17 is an image view showing the exothermic reaction characteristics of the planar heating sheet according to Example 2, FIG. 18 is an image view showing the exothermic reaction characteristics of the planar heating sheet according to Comparative Example 3, FIG. 19 is an image view showing the exothermic reaction characteristics of the planar heating sheet according to Comparative Example 4, and FIG. 20 is an image view showing the exothermic reaction characteristics of the planar heating sheet according to Comparative Example 5.

First, referring to FIG. 17, it can be ascertained that the heating sheet of Example 2 according to the present invention shows the highest exothermic reaction (temperature rises up to 53.3° C. when a voltage of 5.5 V is applied), and can endure a high voltage of 5.5 V, as compared with Comparative Examples 3 to 5.

However, in the case of Comparative Example 3, breakdown occurred after application of a voltage of 4 V, and additional voltage application was impossible.

Further, in the case of Comparative Example 4, a voltage of 5 V could be applied when the first organic compound layer was formed on the base substrate, but breakdown occurred after a voltage of higher than 5 V is applied, and additional voltage application was impossible.

However, as can be seen from Comparative Examples 3 and 4, when the first organic compound layer is formed on the base substrate, the junction characteristics between the base substrate and the silver nanowire and between the silver nanowire and the silver nanowire are improved, so that, when the heating sheet includes the first organic compound layer, a higher voltage can be applied, compared to when the heating sheet does not include the first compound layer.

Further, as can be seen from Comparative Examples 4 and 5, that is, Comparative Example 4 where the first organic compound layer and the silver nanowire are formed on the base substrate and Comparative Example 5 where the first organic compound layer, the silver nanowire, and the second organic compound layer are formed on the base substrate, in the case of Comparative Example 5, it can be ascertained that the second organic compound layer is additionally formed on the silver nanowire, thereby greatly improving the exothermic reaction characteristics of the heating sheet at the time of applying the same voltage.

Further, as can be seen from Comparative Example 5 and Example 2, in the case of the present invention, the metal oxide layer is formed on the second organic compound layer, and thereby, exothermic characteristics are greatly improved when the same voltage is applied.

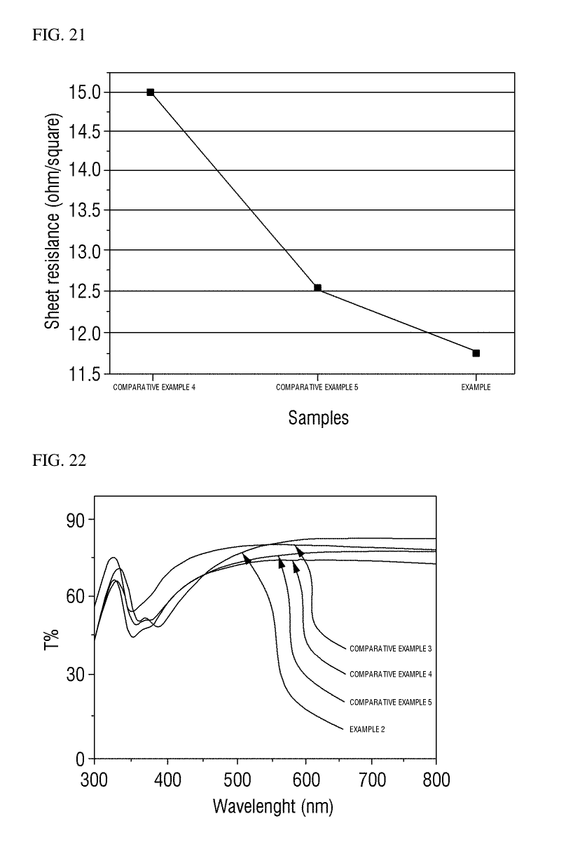

FIG. 21 is a graph showing the resistance characteristics of the planar heating sheets according to Example 2 and Comparative Examples 4 and 5. In this case, in FIG. 21, the resistance characteristics of the heating sheet of Comparative Example 3 were not measured. As described above, in the case of Comparative Example 3, since breakdown occurred after application of a voltage of 4 V and additional voltage application was impossible, Comparative Example 3 corresponds to a meaningless experimental example, so that the resistance characteristics of the heating sheet of Comparative Example 3 were not measured.

Referring to FIG. 21, it can be ascertained that the resistance characteristics of the heating sheet of Example 2 according to the present invention are remarkably excellent as compared with the resistance characteristics of the heating sheets of Comparative Examples 4 and 5. This case of resistance characteristics is consistent with the case of the aforementioned exothermic reaction characteristics of FIG. 5. That is, in the case of Example 2, it can be ascertained that the resistance is reduced and thus the exothermic reaction characteristics are excellent.

FIG. 22 is a graph showing the measured transmittance of Example 2 and Comparative Examples 3 to 5.

Referring to FIG. 22, it can be ascertained that the transmittance of Example 2 and Comparative Examples 3 to 5 is high as a whole. Therefore, it can be ascertained that the planar heating sheet according to the present invention, shown in FIGS. 15 and 16, exhibits the same transmittance as a general house vinyl.

As described above, according to the present invention, since the heating sheet of the present invention is realized by a planar heating member or a linear heating member including a metal nanowire, a second organic compound layer disposed on the metal nanowire, and a metal oxide layer disposed on the second organic compound layer and formed on a base substrate which is a support structure made of a flexible material such as vinyl, plastic, paper, fiber, or the like, this heating sheet can be naturally folded or bent, and thus is very wide in usage.

In this case, as can be seen in Comparative Example 3 and Comparative Example 4 described above, in the case of forming the metal nanowire directly on the base substrate, breakdown occurs when a voltage higher than a certain level is applied, so that no further voltage application is possible, so that it can be ascertained that it is difficult to implement the planar heating sheet.

Therefore, in the present invention, the first organic compound layer is formed on the base substrate to improve the junction characteristics between the base substrate and the metal nanowire and between the metal nanowire and the metal nanowire, so that stable exothermic reaction characteristics can be realized even when a higher voltage is applied.

Hereinafter, in order to compare the characteristics of the first organic compound layer according to the material thereof, the following experiment was additionally carried out.

### Example 3

Example 3 was carried out in the same manner as Example 2, except that polydopamine (PDA) was used as the material of the first organic compound layer.

That is, in the case of Example 3, the heating sheet corresponds to a laminate structure of vinly/polydopamine(PDA)/AgNW/dopamine/TWA.

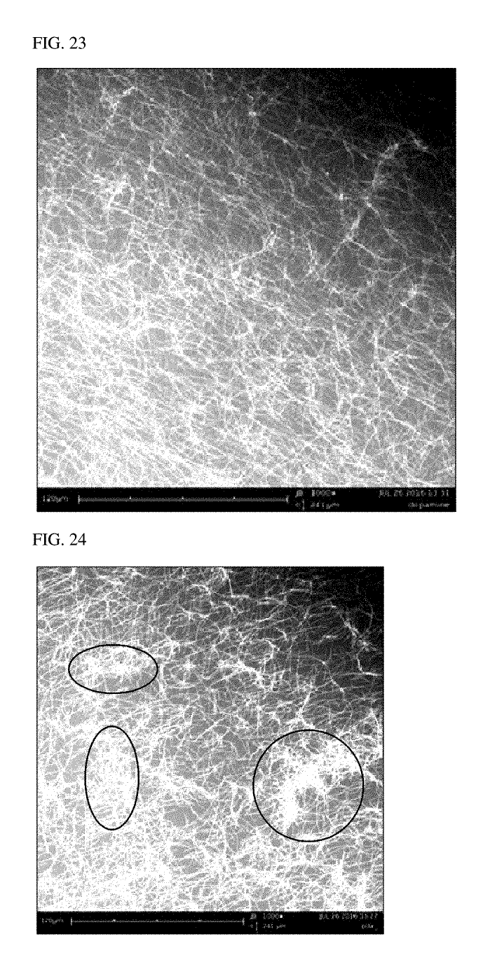

FIG. 23 is a photograph showing a case where the first organic compound layer made of dopamine is formed on the base substrate, and FIG. 24 is a photograph showing a case where the first organic compound layer made of polydopamine is formed on the base substrate. In this case, FIG. 23 corresponds to a laminate structure of vinyl/dopamine/AgNW/TWA, and FIG. 24 corresponds to a laminate structure of vinyl/polydop amine/AgNW/dop amine/TWA.

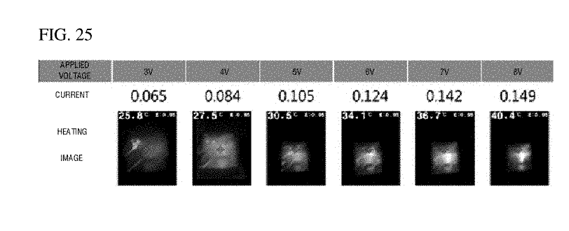

FIG. 25 is an image view showing the exothermic reaction characteristics of the planar heating sheet according to Example 3.

First, referring to FIG. 23, it can be ascertained that when the first organic compound layer is formed of dopamine on the base substrate, silver nanowires, which are metal nanowires, are relatively uniformly applied. In contrast, referring to FIG. 24, it can be ascertained that when the first organic compound layer is formed of polydopamine on the base substrate, silver nanowires, which are metal nanowires, are concentrated in some regions, and thus are relatively non-uniformly applied.

Next, referring to FIG. 25, as compared with the above-described FIG. 17, it can be ascertained that when a voltage of 5.5 V, which is the same voltage, was applied, the heating sheet of Example 2 generated heat up to 53.3° C., whereas the heating sheet of Example 3 generated heat up to 30.5° C.

That is, it can be ascertained that the exothermic characteristics of the heating sheets of Examples 2 and 3 are partially different from each other depending on the material of the first organic compound layer formed on the base substrate.

However, in the case of Example 3, as compared with Example 2, it can be confirmed that the heating temperature measured at the same voltage is low, but the heating can be stably performed until a voltage of 8 V is applied.

Therefore, in the present invention, it is preferable to use dopamine as the material of the first organic compound layer in terms of exothermic reaction characteristics. However, it is preferable to use polydopamine in terms of stability at high voltage.

Although preferred embodiments of the present invention have been described for illustrative purposes, those skilled in the art will appreciate that various modifications, additions and substitutions are possible, without departing from the scope and spirit of the invention as disclosed in the accompanying claims.

1. A heating wire, comprising:
a metal nanowire;
an organic compound layer applied on the metal nanowire; and
a metal oxide layer applied on the organic compound layer.

2. The heating wire of claim 1,
wherein the organic compound layer is made of catecholamine or a derivative thereof.

3. The heating wire of claim 2,
wherein the catecholamine is at least one selected from the group consisting of dopamine, dopamine-quinone, alpha-methyldopamine, norepinephrine, epinephrine, alpha-methyldopa, droxidopa, and 5-hydroxydopamine.

4. The heating wire of claim 1,
wherein the metal oxide layer is made of molybdenum (Mo) oxide or tungsten (W) oxide.

5. A planar heating sheet, comprising:
a linear heating member including a single fiber body and a plurality of heating wires surrounding the single fiber body,
wherein the heating wire includes a metal wire, an organic compound layer applied on the metal wire, and a metal oxide layer applied on the organic compound layer.

6. The planar heating sheet of claim 5, comprising:
the plurality of linear heating members
wherein the plurality of linear heating members are irregularly arranged.

7. The planar heating sheet of claim 5, further comprising:
a first electrode connected with one side of the plurality of linear heating members; and
a second electrode connected with the other side of the plurality of linear heating members,
wherein a power is applied to the first electrode and the second electrode, and thereby the heating wire generates heat.

8. The planar heating sheet of claim 5,
wherein the metal nanowire has a length of 10 to 50 μm.

9. The planar heating sheet of claim 5,
wherein the organic compound layer is made of catecholamine or a derivative thereof.

10. The planar heating sheet of claim 9,
wherein the catecholamine is at least one selected from the group consisting of dopamine, dopamine-quinone, alpha-methyldopamine, norepinephrine, epinephrine, alpha-methyldopa, droxidopa, and 5-hydroxydopamine.

11. The planar heating sheet of claim 5,
wherein the metal oxide layer is made of molybdenum (Mo) oxide or tungsten (W) oxide.
